(19) United States
(12) Patent Application Publication
(10) Pub. No.: US 2004/0133133 A1
(43) Pub. Date: Jul. 8, 2004

(54) Massage device

(76) Inventors: Samantha Dreimann, Lake Forest, IL (US); Steven Charles Lund, Clearwater, FL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/337,600

(22) Filed: Jan. 7, 2003

(51) Int. Cl. A61H 23/02

(52) U.S. Cl. 601/15; 601/70

(57) ABSTRACT

A massage vest for personal use. The massage vest has portions corresponding to body areas. The portions include a back portion, a front portion and an upper portion wherein the back portion covers the back of a torso, the front portion covers the stomach while the upper portion covers the shoulders. At least one transducer is coupled to the garment for imparting motions to provide massage motion to the torso while the user wears the vest. A controller is in communication with the at least one transducer to energize the at least one transducer.

### BACKGROUND OF THE INVENTION

The present invention relates to a massage device, and more particularly concerned with methods and apparatus for a massage garment. The massage garment incorporates an array of transducers transmitting energy to a cushioned member, such as a personal vest.

Massage devices are common personal care products used to provide muscle relief for consumers. In the past, it has been the conventional practice to provide therapeutic chairs having vibrators in the seat and the seat back for imparting a vibratory motion or movement to the person occupying the chair. In other instances, such as when mattresses are employed, a vibrator is placed under or in the box springs or on the bed frame so that vibrating oscillations are transmitted into the structure of the mattress. Such movements are therapeutic to the user's body portions receiving the vibration; however, the movements are extremely limited to mere jiggling or, at best, rapid back and forth movements. Generally, these typical vibratory movements are a series of hard raps to the cushion of the mattress or chair. The imparted movements or vibrations are very local in their reception by the user's body or occupant of the chair or mattress and incorporate hard impacts to the bone structure or body physiology of the occupant.

Other massage devices include smaller pads that are placed in chairs and beds. These devices are movable to different locations providing massage therapy while the user temporarily sits or lies down. A problem with these known massage devices, however, is the limited flexibility the massage devices provide to the user. For example, the massage device requires it to be fixed to the apparatus and/or supported by the apparatus such as the chair or bed. Thus, the user can only use the massage device while positioned in the respective apparatus. The device, however, is not conveniently accessible when the user requires a massage while not positioned in the chair or bed. Accordingly, the pad massagers present a lack of portability and convenience for the user. As such, these devices are not conveniently accessible when the user requires or desires a massage in a different location. For example, the user may require or desire the massage therapy while the user is mobile such as being active outdoors or at work.

Therefore, a long-standing need has existed to provide a novel massage or therapeutic device, such as a garment, having integrally installed transducers arranged in selective groups or arrays which will impart a variety of vibratory movements to the user. The solution, however, must be conveniently mobile for the user. Thus, a need exists for a massage device that does not require another fixture in order to be properly supported. Accordingly, the solution must be self contained. Further, a need exists for a massage device that the user can wear as a vest. The solution, however, must be easily put on, worn and taken off by the user, in a comfortable fashion.

### SUMMARY OF THE INVENTION

The present invention relates to a massage device, and more particularly concerned with methods and apparatus for a massage garment. The massage garment incorporates an array of transducers transmitting energy to a cushioned member, such as a personal vest. Accordingly, the known problems are overcome by the present invention which provides a novel massaging garment.

In an embodiment, the garment comprises a vest having portions which cover a body area such as the torso. The invention couples transducers to impart energy to the garment wherein a controller activates the transducers.

In an embodiment, the garment includes a back portion, a front portion and an upper portion to cover the torso wherein the transducers may be positioned in the portions.

In a method of use, the user surrounds a body area, such as the torso, with a garment. The user then positions a portion of the garment around the body area. Then, a massage effect is created by activating a plurality of transducers positioned within the portion. The user then controls the transducers via a controller.

In an embodiment, the portion includes a back portion, a front portion and an upper portion to cover the torso. Further, in an embodiment, the transducers are activated automatically or manually.

An advantage of the present invention is to provide a garment that can be easily and comfortably worn by a user to receive massage therapy.

Another advantage of the present invention is to provide a garment having portions which surround a body area and provides massage therapy through the portions.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a front view of a massage device embodying principles of the present invention.

FIG. 2 is a back view of an embodiment of the present invention shown in FIG. 1.

FIG. 3 is an enlarged perspective view illustrating in detail a component of the device of FIG. 1.

FIG. 4 is a cross sectional view of the component taken in the direction of arrows 3-3 of FIG. 3.

FIG. 5 is a block diagram illustrating an effective electrical system for energizing a device embodying the present invention.

FIGS. 6 and 6a depict a circuit schematic of the electrical system of FIG. 5.

FIG. 7 is a front view of another embodiment of the present invention in a closed position.

FIG. 8 is a back view of the embodiment of FIG. 7 in an open position.

FIG. 9 is a front view of another embodiment of the present invention.

FIG. 10 is a front view of another embodiment of the present invention.

FIG. 11 is a back view of another embodiment of the present invention.

FIG. 12 is a perspective view of another embodiment of the present invention.

FIG. 13 is a front view of the embodiment shown in FIG. 12.

### DESCRIPTION OF THE PREFERRED EMBODIMENTS

As discussed, the present invention provides structures and other accommodations to generate singular or simultaneous multiple movements useful in massaging of body areas such as the torso of the user. Movement or motion, as used herein, refers to simultaneous movements, a single movement, multiple programmable movements separately or in unison, or any combination thereof, and massage includes the production of travelling vibratory motion, rolling motion, in-place vibratory movement, tapping, pulse, knead and wave motion as applied to specified or random areas of the user's body by the apparatus.

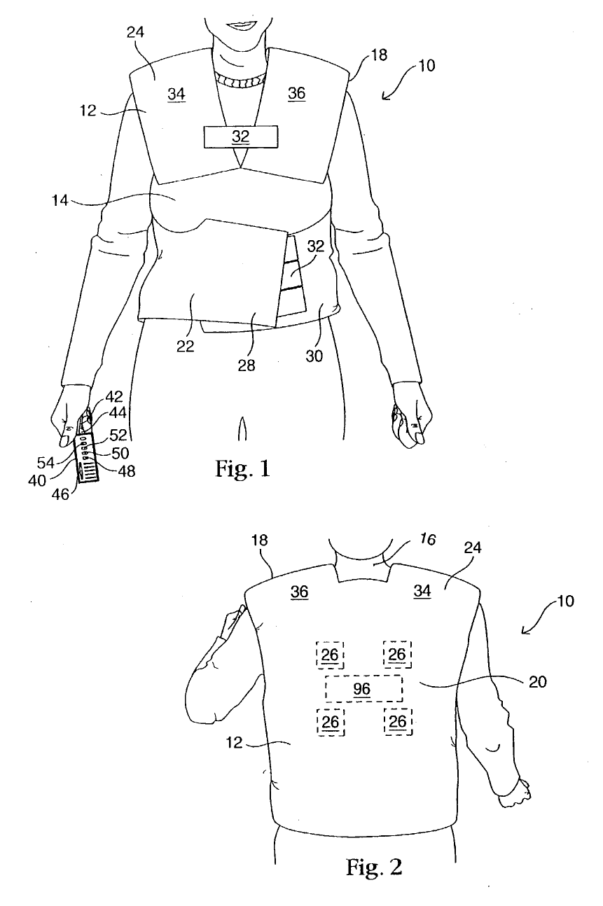

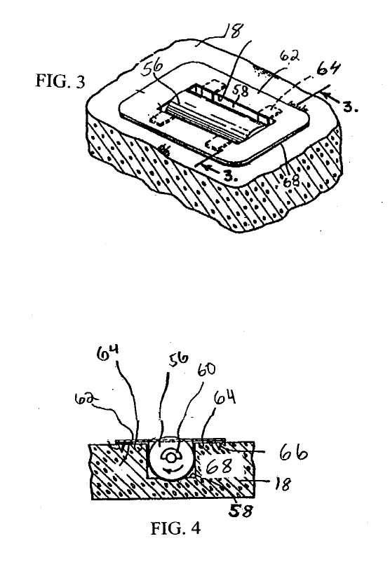

FIGS. 1 and 2 illustrate an exemplary massage device 10 incorporating the present massage therapy to portions 12 corresponding to body areas 14 such as the torso 16. The massaging device 10 as shown includes a garment 18, in particular, a vest.

The massage device 10 comprises a back portion 20, a front portion 22 and an upper portion 24. As further illustrated in FIG. 2, groups of transducers 26 are associated on the garment 18 for translating mechanical movement or motion of each transducer 26 into massage motions induced into the material of the garment 18 which, preferably, is composed of an open-celled foam composition.

As shown in FIG. 1, the front portion 22 covers the stomach of the body area 14 while the upper portion 24 covers the shoulders of the body area 14. In the embodiment shown, the front portion 22 includes a first side 28 and a second side 30 to cover the stomach. Accordingly, a fastener 32, such as Velcro®, connects the first side 28 with the second side 30. Additionally, the upper portion 24 comprises a first upper side 34 and a second upper side 36 wherein the first upper side 34 covers one shoulder of the body area 14 while the second upper side 36 covers the other shoulder. Another fastener 32 connects the first upper side 34 and the second upper side 36. As shown in FIG. 2, the back portion 20 covers the back of the torso 16.

Transducers 26 impart energy in a zone related to the back portion 20 when the user wears the garment 18. These transducers 26 operate whether the garment 18 is opened or closed by the fastener 32. Although groups of two transducers 26 are shown associated with the back portion 20, additional transducers 26 can be arranged in groups or arrays within the back portion 20 in a variety of different patterns.

Turning to FIG. 2, the transducers 26 are located preferably in alignment between the opposite ends of the back portion 20 inwardly from the edge marginal regions and disposed a distance from the top and bottom of the back portion 20 so that the groups of the transducers 26 are situated in a central area with respect to the torso 16. The transducers 26 are arranged in substantially fixed spaced-apart relationship and each group may be composed of two or more transducers 26 of different sizes, weights or dimensions. However, it is to be understood that any array, group of transducers 26 or single transducer 26 may also be used to constitute a particular massage zone within the back portion 20. It is further understood that transducers 26 may be positioned in a variety of patterns.

Returning to FIG. 1, a controller 40 energizes or activates the plurality of transducers 26 arranged in the various groups for inducing the motions into the cushion material of the garment 18. The controller 40 couples to the transducers 26 via a plug 42 and socket 44 while being powered by a battery pack (not shown) or an outlet (not shown). Accordingly, the controller 40 may be powered by an AC/DC adapter.

The controller 40 may include a manually operated slider control 46 used as a speed control while a pushbutton 48 is employed for manual sequencing of the transducers 26 between the various groups or arrays. A multi-position switch 50 is used for selection between multiple levels of intensity while a conventional on/off switch 52 is used as a power switch. The controller 40 may include multiple speed and intensity settings such as low, medium and high. A display for indicating the particular zone or group of transducers 26 that are in operation at any one time is displayed by lights, such as light 54.

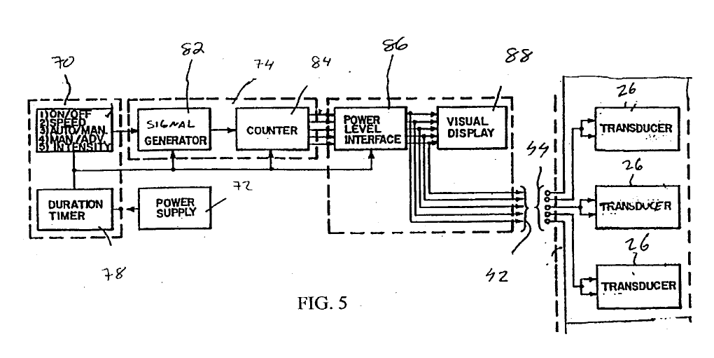

Referring now to FIGS. 3 and 4, it can be seen that the transducers 26 may take the form of an electric motor 56 which is mounted in a depression or receptacle 58 provided in the portion 12 (shown in FIG. 1), such as the back portion 20 (shown in FIG. 2). It is understood that the transducers 26 may take the form of other motion generators such as vibrators. In the embodiment shown, the composition surrounding the motor 56 is soft and pliable; however, it is stiff enough to carry motions from the motor 56 for dispersal throughout the composition into the torso 16 of the user wearing the garment 18.

The motor 56 includes an eccentric weight 60 mounted on its drive shaft so that a jiggling or oscillating movement is generated as the drive shaft is rotated. The motor 56 may mount to the underside of a mounting plate 62 by means of a pair of straps 64. Downwardly depending spikes 66 embed themselves into the composition so that the mounting plate 62 will not move once it has been adhesively bonded to the surface of the garment 18. The adhesive bonding is indicated by an adhesive layer 68. Therefore, it can be seen that as the motor 56 is driven via the electrical circuit, the motor 56 will vibrate by virtue of the eccentric drive shaft arrangement so that oscillating movement will be introduced into the cushion material via the mounting plate 62 so that the immediate area of each motor 56 produces a massaging action into the torso 16 of the user.

Referring now in detail to FIG. 5, a switch 70 permits the user to select a variety of operations and operating parameters by interconnecting a power supply 72 to a signal generator 74 so that a timed signal train is forwarded to an interface that is connected to the plurality of transducers in the garment 18.

The switch 70 includes the provision for a duration timing circuit 78 which will automatically shut the power off after a preselected period of time such as fifteen minutes. Within this operating time, selection switches are moved by the user not only to turn the unit on and off to supply power but to adjust travelling speed, intensity and a variety of other operating parameters. Once selection of the parameters has been chosen by the user and the switches so actuated, the power is supplied to a signal generator 82, such as a pulse train generator, that constitutes a duty cycle of spaced-apart signals which are introduced to a counter 84.

Once the counter 84 has been actuated, an output is provided to a power level interface 86. It is to be understood that the sequence may be in series and is not a parallel output on all lines since it is this sequence which will determine the automatic energization of the respective transducers 26 in the various zones. However, should the selector switch in the switch 70 be set at manual, then a single output line from the counter will be activated so that only the selected transducer 26 zone or group will be energized. The power level interface 86 brings the output from the counter to a desired power level for operating of the transducers 26 and a visual display means 88 where the operating lights for the zones, such as light 54, are located. However, the output from the power level interface 86 is provided directly through the plug 42 and socket 44 relationship to the various transducers 26 in the respective zones or groups. Additionally, the strength of vibration, as well as speed of motor 56, is determined by the setting of the switches in the selection switches 70.

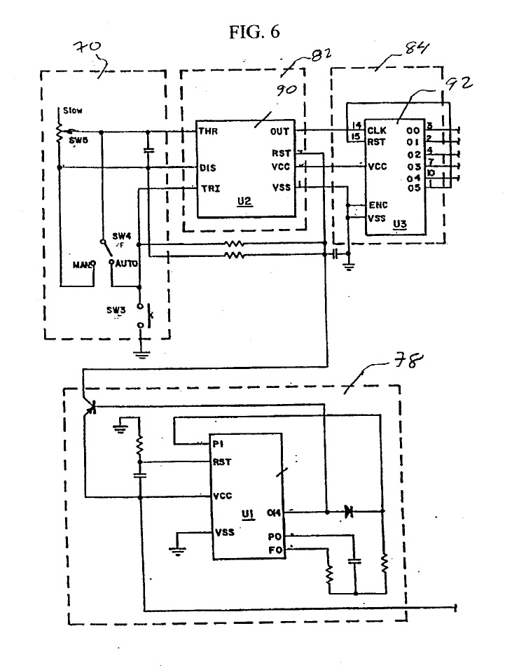

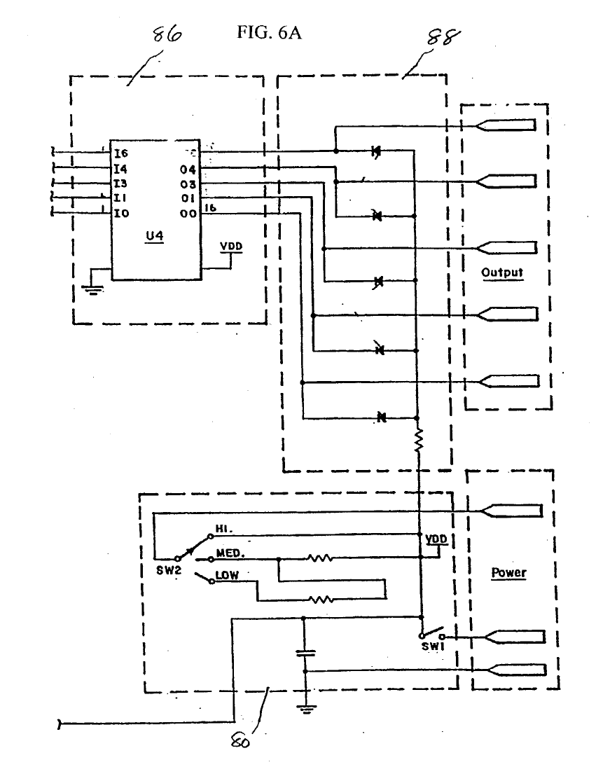

Referring now in detail to FIGS. 6 and 6A, it can be seen that the selection switches 70 are divided between the blocks wherein SW1 is the on/off switch connecting the power supply 72 to the unit. The switch SW2 is employed for selecting intensity of signal while switch SW3 is a pushbutton type to be used by the user in manually sequencing the application of power to the transducers 26 in the respective zones when the switch SW4 is in the manual position. However, if switch SW4 is in the auto position, the sequence is automatic and the movement of the signals is automatic.

The switch SW5 is employed for selecting travelling speed and includes nomenclature of low, medium and high so that the user has a visual view of the positions as the slider control 46 (shown in FIG. 1) is moved. Movement of the slider control 46 resistor selects a repetition rate of the signals generated by a generator such as multivibrator 90 taking the form of an electronic chip U2. This chip operates as a debouncer to feed clean pulses to the counter 92 during manual sequencing operation. Additionally, the duration timer 78 includes a chip identified by U1. Further, the output from the signal generator 82 is to the counter 84 having chip U3 wherein the output from the counter 84 is in a spaced sequence along its multiple output lines and is fed directly to an interface circuit 86 having a power chip U4.

After the proper power level has been achieved, the output from the interface circuit is provided to the lights 54 for display on the controller 40 so that the user may know which of the vibrating groups or arrays of transducers 26 are being energized. The output from the power level interface 86 may also be provided to the respective groups of transducers 26 in the ordered sequence selected by the automatic switch SW4 or the manual setting of the switch when manually sequenced via the manual advance pushbutton SW3.

It is understood that the controller 40 also allows the user to activate transducers 26 which provide motions such as pulse motion. Additionally, the transducers 26 may impart tapping, kneading, rolling, pulse, vibrating and wave motion to the garment 18. Further, these different motions may be imparted in the automatic and the manual modes.

Returning to FIG. 2, at least one heater 96 is associated with the garment 18. As shown, the heater 96 applies heat to the back portion 16 to further enhance the massage effect as known in the art. Accordingly, the controller 40 activates the heater 96 alone or in combination with the transducers 26. As such, the controller 40 may activate different heat settings such as low, medium and high. The controller 40 may also activate the heater 96 on variable scale as known in the art.

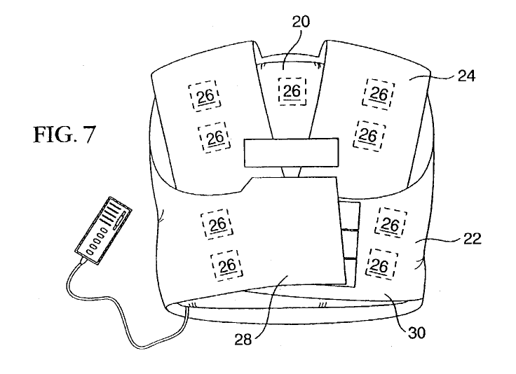

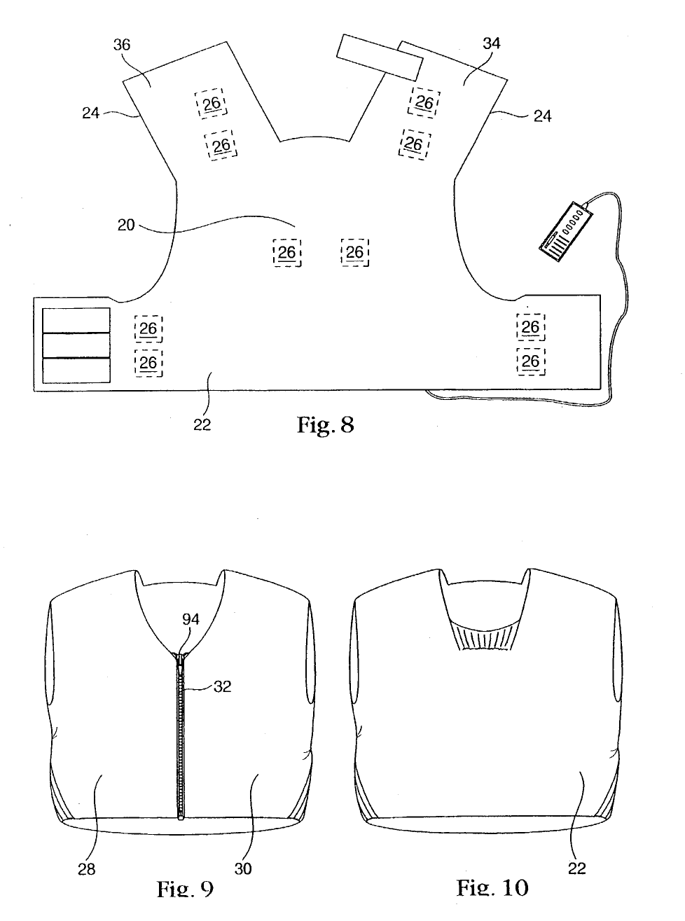

Turning to FIGS. 7 and 8, another embodiment is shown. In this embodiment, transducers 26 are associated with the front portion 22 and the upper portion 24 in addition to the back portion 20. As shown in FIG. 7, the transducers 26 are positioned in the first side 28 and the second side 30 to impart the energy to the stomach. Turning to FIG. 8, transducers 26 are positioned within the first upper side 34 and the second upper side 36. Similar to the transducers 26 in the back portion 20, the transducers 26 in the front portion 22 and the upper portion 24 are configured within the receptacles 58 (shown in FIGS. 3 and 4) and may be positioned individually or in groups within the front portion 24 and the upper portion 26. In another embodiment, heaters 96 may be associated with the front portion 22 and the upper portion 24 wherein the heaters 96 may supply heat individually or in combination to the front portion 22 and the upper portion 24.

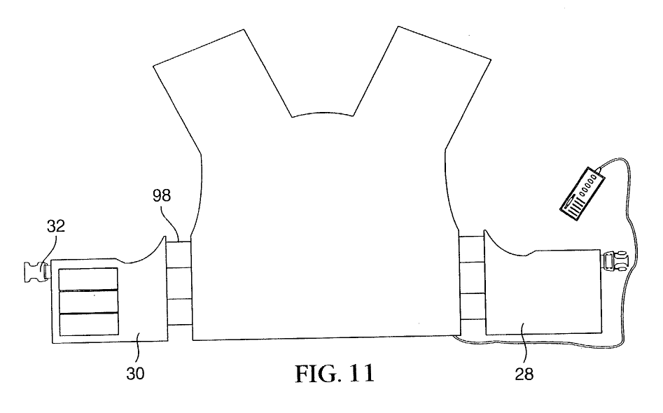

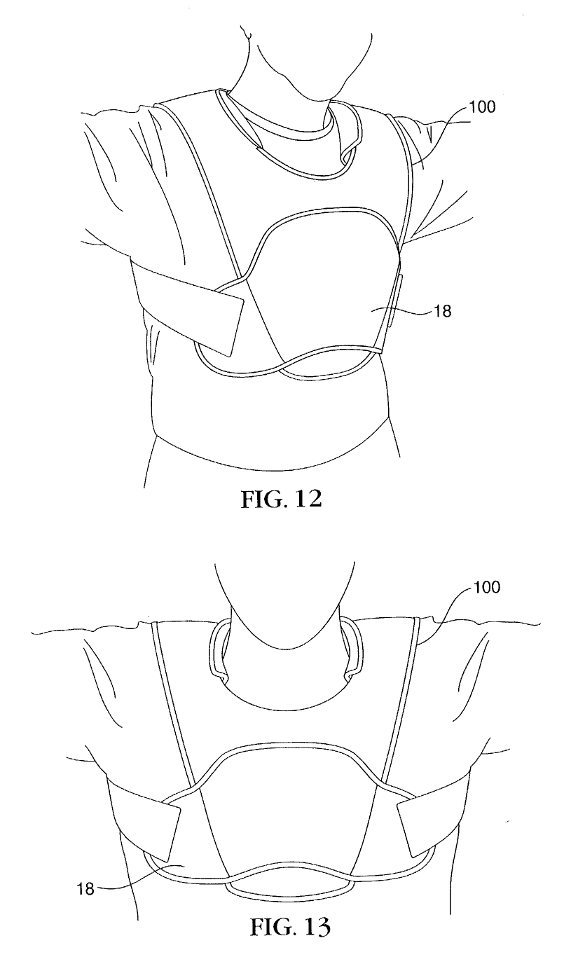

Turning to FIG. 9, another embodiment is shown. In this embodiment, the fastener 32 comprises a zipper 94 to connect the first side 28 and the second side 30. FIG. 10 also shows another embodiment. In this embodiment, the front portion 22 is one piece, combining the first side 28 and the second side 30. Accordingly, in this embodiment, the garment 18 comprises a pull-over type vest. Turning to FIG. 11, another embodiment is shown. In this embodiment, the first side 28 and the second side 30 may use extensions 98 to adjust for different sizes. Fastener 32 such as quick release clips may also be used to connect the first side 28 and the second side 30. These fasteners 32 may also adjust to accommodate different sizes. Turning to FIGS. 12 and 13, another embodiment is shown. In this embodiment, the garment 18 incorporates wider arm apertures 100 to allow more freedom in movement. It is understood that the controller 40, transducers 26 and heaters 96 may be associated with these embodiments.

In view of the foregoing, it can be seen that the massaging apparatus of the present invention is useful in the field of massage motions for the comfort and therapeutic purposes as applied to a user and which may be incorporated into the garment 18, such as a vest, to provide a lightweight, easily transportable garment 18 which surrounds the torso 16. The transducers 26 and heaters 96 may be incorporated into all shapes and configurations of garments 18, including but not limited to the garments 18 illustrated. When not in use, the garment 18 may fold up for easy carrying.

In use, the present invention produces a massage effect including travelling vibratory motions, localized vibratory or oscillatory motions, rolling motions, pulse motions, tapping motions, knead motion and wave motion, or combinations thereof by associating one or more transducers 26 inside the garment 18 wherein the transducers 26 are activated or energized by the controller 40. The positioning of the plurality of transducers 26 in a multiple of groups provides zones of massage motions which may be located in fixed areas, in selectable areas or when programmed appropriately, to move smoothly around the torso 16 in a travelling movement. Also, induced motions effects may be programmed to be applied in more complex patterns or even randomly.

In use, the user puts on the garment 18 and preferably connects the first side 28 and the second side 30 with the fastener 32. The user then activates the controller 40 to energize the transducers 26. The controller 40 operates the transducers 26 in either automatic or manual modes. In an automatic mode, power is applied to each zone of transducers 26 provide the massage effect to the torso 16. In another embodiment, power is applied to each zone of transducers 26 sequentially such as from the back portion 20 to the upper portion 24

We claim:

1. A massage device wearable by a user, comprising:
a garment, the garment having portions corresponding to body areas of the user;
at least one transducer, the at least one transducer associated with the garment for imparting motions thereto; and
a controller, the controller being in communication with the at least one transducer wherein the Controller sends signals to the at least one transducer to energize at least one transducer to generate motions within the garment.

2. The massage device according to claim 1, further comprising a counter for converting the signals into a series of signals on multiple output lines.

3. The massage device according to claim 2, further comprising a power level interface between the multiple output lines and the transducers, whereby the signals are selectively and sequentially applied to independent ones of the transducers.

4. The massage apparatus according to claim 3, further including a display for indicating which of the transducers is imparting energy, and wherein the power level interface is coupled to the transducers and the display.

5. The massage device according the claim 1, further comprising at least one heater positioned within the garment.

6. The massage device according to claim 1, wherein the garment is a vest.

7. The massage apparatus of claim 1, wherein the body areas include the torso.

8. The massage device according to claim 7, wherein the portions include a back portion, a front portion and an upper portion.

9. The massage device according to claim 8, wherein the back portion covers the back of the torso.

10. The massage device according to claim 8, wherein the upper portion substantially covers the shoulders of the torso.

11. The massage device according to claim 8, wherein the front portion includes a first side and a second side to substantially cover the stomach of the torso.

12. The massage device according to claim 11, further comprising a fastener to connect the first side and the second side.

13. The massage device of claim 1, wherein the transducers are vibrators.

14. The massage device according to claim 1, wherein the transducers provide a pulse massage.

15. The massage device according to claim 1, wherein the transducers provide a tapping massage.

16. The massage device according to claim 1, wherein the transducers provide a kneading massage.

17. The massage device according to claim 1, wherein the transducers provide a wave massage.

18. The massage device of claim 1, wherein the controller includes a pulse generator for generating a train of electric pulses.

19. The massage device of claim 18, wherein the electric pulses are rectangular shaped pulses.

20. The massage device according to claim 18, wherein the pulse generator includes a multivibrator.

21. A massage garment, comprising:
a cushioned vest, the cushioned vest having portions corresponding to and surrounding body areas including a back portion, a front portion, and an upper portion, the cushioned vest further having receptacles arranged in a pattern;
a plurality of transducers, the plurality of transducers being operably associated with the cushioned vest for generating motions in a predetermined pattern, the plurality of transducers positioned within the receptacles in relationship consisting a multiplicity of massage zones within the cushioned vest; and
a hand-held controller, the hand-held controller energizing the plurality of transducers by signals to generate the motions in the cushioned vest.

22. The massage garment according to claim 21, further comprising at least one heater positioned in the cushioned vest.

23. The massage garment according to claim 21, further comprising a switch coupled to the controller and being selectively switchable to enable the plurality of transducers to operate in one of an automatic and a manual mode.

24. The massage garment according to claim 23, wherein the switch, when operable in its automatic mode, enables to drive the plurality of transducers in a selected sequence so that selected ones of the transducers independently generate motion in response to the controller.

25. The massage garment according to claim 23, wherein the switch, when operable in its manual mode, enables to drive to a particular one of the plurality of transducers in response to the controller.

26. The massage garment according to claim 21, wherein the front portion includes receptacles arranged in a pattern.

27. The massage garment according to claim 21, wherein the upper portion includes receptacles arranged in a pattern.

28. The massage garment according to claim 21, wherein the back portion includes receptacles arranged in a pattern.

29. The massage garment according to claim 28, wherein the plurality of transducers are positioned within the receptacles in a relationship consisting of massage zones with the back portion.

30. A method of a user using a massage garment, comprising:
positioning a portion of a vest around a body area;
creating a massage effect on the portion by activating a plurality of transducers positioned within the portion; and
controlling the activation of the plurality of transducers.

31. The method of use according to claim 30, further comprising supplying heat to the vest.

32. The method of use according to claim 31, wherein the heat is applied to the portion.

33. The method of use according to claim 30, wherein the body area is a torso.

34. The method of use according to claim 30, wherein the portion is at least one of a back portion, a front portion and an upper portion.

35. The method of use according to claim 34, further comprising activating the plurality of transducers in the back portion, the front portion and the upper portion in a sequence.

36. The method of use according to claim 34, further comprising activating the plurality of transducers in the back portion, the front portion and the upper portion simultaneously.

37. The method of use according to claim 34, further comprising activating the plurality of transducers in the back portion, the front portion and the upper portion independently.
